(19) United States
(12) Patent Application Publication
(10) Pub. No.: US 2024/0217862 A1
(43) Pub. Date: Jul. 4, 2024

(54) METHOD FOR PRODUCING GLASS FIBER NOZZLES, AND GLASS FIBER NOZZLE

(71) Applicant: Heraeus Deutschland GmbH & Co. KG, HANAU (DE)

(72) Inventors: Jakob FISCHER, Hanau (DE); Lisa MEYER, Hanau (DE); Sascha SAGER, Hanau (DE); Stefan LANG, Hanau (DE); Stefan VORBERG, Hanau (DE); Stephan HERBST, Hanau (DE)

(21) Appl. No.: 17/905,804

(22) PCT Filed: Feb. 12, 2021
(86) PCT No.: PCT/EP2021/053467

§ 371 Date: Sep. 7, 2022

(30) Foreign Application Priority Data
Mar. 12, 2020 (DE) 10 2020 106 745.3

(51) Int. Cl. C03B 37/08; B33Y 10/00; B33Y 30/00; B33Y 40/00; B33Y 70/00; B33Y 80/00; C03B 37/083; C03B 37/095

(52) U.S. Cl. CPC C03B 37/0805; C03B 37/083; C03B 37/095; B33Y 10/00; B33Y 30/00; B33Y 40/00; B33Y 70/00; B33Y 80/00

(57) ABSTRACT

A method for producing glass fiber nozzles, comprising the steps of:
A) providing or producing a base plate comprising a first material, being chemically resistant to the glass melt and dispersion strengthened,
B) printing at least one tube made of a second material being chemically resistant to the glass melt onto one side of the base plate, wherein the at least one tube each comprise at least one feedthrough,
C) generating at least one passage in the base plate, the passage is connected to at least one of the at least one feedthrough in such a way that each of the at least one passage through the base plate forms a common line permeable to the glass melt, with at least one of the at least one feedthrough of an associated tube leads through the base plate and through the associated tube.

The invention relates to a method for producing glass fiber nozzles. The invention also relates to a glass fiber nozzle and to a method for producing glass fibers.

Glass fiber nozzles for drawing technical glass fibers can be produced by pouring a glass melt through openings in a base plate of a glass trough. For this purpose, a glass fiber nozzle can be welded together from a box-shaped structure with a perforated base plate, wherein tubes or so-called tips having a cylindrical or conical form are welded into the holes of the base plate. Certain tube geometries are advantageous, but in some cases are only difficult to produce with conventional methods. The glass fiber nozzles are equipped with up to 8,000 tubes (tips). The liquid glass (or the glass melt) runs through the glass fiber nozzle through these tubes. The cooling of the glass results in solid glass fibers. The tubes have a significant influence on the quality of the glass fibers and on the service life of the glass fiber nozzle.

US 2016/0312338 A1 discloses a glass fiber nozzle made of a platinum-rhodium alloy, with which a plurality of tips are arranged on one side of a base plate (“bushing”). In this case, the tips are arranged on a plurality of passages through the base plate and extend the latter. The glass melt can flow through the passages and tips to produce glass fibers. The tips are either welded on or they are produced in one piece with the base plate and together with the base plate. The tips should consist of the same material as the base plate. A one-piece production of the base plate with the tips and the passages is complicated. In addition, with such a production the base plate cannot be rolled to achieve stiffening and an improvement in the durability of the base plate. Where the tips are welded into the passages or to the passages of the base plate, the welded connection is a weak point of the glass fiber nozzle. In addition, all tips have to be welded individually to the base plate, which is time-consuming. Welding can result in unwanted changes in the geometry inside the tips, which influence the properties of the glass fibers. In addition, production is very complicated. Especially if the tips are to be precisely positioned. The inner shape of the tips is usually very limited due to the material used and the desired material properties. In a one-piece production, a thick base plate can be rolled, the tips (pressed plates) can be formed and the rear side can then be milled to a target thickness. The disadvantage here is a high use of materials and associated high costs.

The object of the invention is to overcome the disadvantages of the prior art. In particular, a way is to be found to produce and provide a glass fiber nozzle that is as inexpensive as possible and at the same time also allows the realization of different geometries for the tubes. In addition, the glass fiber nozzle must be stable not only with respect to the glass melt but also with respect to the high temperatures during use. A controlled cooling of the tubes should be possible so that the glass fiber nozzle can be used as long as possible before it has to be completely replaced or at least repaired. The glass fiber nozzle should be able to produce new glass fibers suitable for specific applications.

The objects of the invention are achieved by a method for producing glass fiber nozzles that are provided for producing glass fibers from a glass melt, the method comprising the steps of:
A) providing or producing a base plate comprising a first material, wherein the first material is chemically resistant to the glass melt and dispersion strengthened,
B) printing at least one tube made of a second material onto one side of the base plate, wherein the at least one tube in each case comprises at least one feedthrough and wherein the second material is chemically resistant to the glass melt,
C) generating at least one passage in the base plate, wherein the at least one passage through the base plate is connected to at least one of the at least one feedthrough of one of the at least one tube in each case in such a way that each of the at least one passage through the base plate forms a common line, which is permeable to the glass melt, with at least one of the at least one feedthrough of an associated tube of the at least one tube, which line leads through the base plate and through the associated tube, and wherein the base plate is produced using a method other than the one used for the at least one tube.

When speaking about glass fiber nozzles, the tubes are also frequently referred to as tips. The at least one tube can thus be at least one tip.

In the present case, a tube is understood to mean a tube having a general geometry. By no means are the tubes limited to a cylindrical or rotationally symmetrical geometries. For example, the tube can also have the shape of a torus (donut shape), also with an elliptical cross section. In particular, the at least one feedthrough in the at least one tube can have a geometry that influences the flow of the glass melt in and through the at least one feedthrough. For example, a rotation of the flowing glass melt can be achieved by the inner shape of the at least one feedthrough. The geometry of the tubes and thus of the emerging fibers does not have to be constant over the bottom plate surface. The shape of the tubes can vary both in terms of size and in terms of shape and geometry.

As a result of suitable adaptation, a more homogeneous melt exit and lower thermal fluctuation can be achieved, and a different fiber geometry can be produced during outflow from a sheet or from a trough.

According to the invention, the at least one tube can have a constriction or widening in the at least one feedthrough. The constriction can then act as a nozzle for ejecting the glass melt to produce the glass fiber. The widening can influence the flow behavior, in particular the flow rate of the glass melt.

The second material is a different material from the first material.

Preferably, a powdery second material or a wire-shaped second material is used in step B), particularly preferably a powdery second material.

According to the invention, the powdery second material can preferably have an average grain size of less than 50 μm. It can be provided for the powdery second material to be screened for limiting the particle size, preferably with a sieve of the fraction 200 μm or less, particularly preferably with a sieve of the fraction 100 μm to 50 μm, very particularly preferably with a sieve of the fraction 50 μm. The wire-shaped second material preferably has a diameter of less than 200 μm, preferably of less than 50 μm.

It can preferably be provided for step C) to take place before step B) or after step B).

According to the invention, the base plate can be a sheet, preferably a metal sheet, particularly preferably a sheet made of a noble metal or a noble metal-based alloy, very particularly preferably a sheet made of platinum or a platinum-based alloy or a platinum-rhodium alloy, especially preferably a sheet made of a PtRh10 alloy.

The first material is preferably an oxide dispersion hardened platinum (DPH) or an oxide dispersion hardened platinum-rhodium alloy, very particularly preferably oxidation-hardened PtRh10.

In methods according to the invention, it can be provided that the base plate is not produced using a laser melting method, a laser sintering method, an electron beam melting method or an electron beam sintering method. In methods according to the invention, it can also be provided that the base plate is not produced using a layered 3D printing method.

As a result, the base plate can be designed in a particularly stable manner with respect to the temperature and the chemical environment. Moreover, it is also possible to use a more cost-effective method for producing the base plate than is possible with the aforementioned methods.

Furthermore, it can be provided for a step A1) to be performed before step A):
A1) producing the base plate using a method comprising melt casting and/or rolling, in particular melt casting and subsequent rolling.

With this method as well, a particularly stable and high-temperature-resistant base plate can be produced, wherein the variability of the printing method can be used at the same time for the at least one tube.

Furthermore, it can be provided that a dispersion-strengthened, in particular oxide dispersion hardened metal material is used as the first material, wherein the first material delimits all surfaces coming into contact with the glass melt.

Furthermore, it can be provided that a dispersion-strengthened noble metal or a dispersion-strengthened noble metal alloy which is dispersion strengthened with ceramic particles, in particular with ceramic ZrO₂ particles, is used as the dispersion-strengthened metal material.

It can also be provided that a platinum or platinum-rhodium alloy, each of which is oxide dispersion hardened with ceramic particles, with oxidic particles or with ceramic ZrO₂ particles, is used as the first material. Preference is given to using a dispersion-strengthened PtRh10 alloy.

The ceramic particles, in particular the oxidic or ZrO₂ particles, are preferably distributed in the metallic matrix of the first material in order to effect dispersion strengthening. An oxide dispersion-strengthened alloy is preferably used as the dispersion-strengthened first metal material.

By using this material, a high-density base plate which is stable at high temperatures and is particularly chemically resistant to the glass melt can be produced, wherein at the same time the at least one tube with variable and also with complex geometry can be printed on the base plate.

It can be provided for the base plate to consist of the first material.

As a result, the base plate can be produced particularly cost-effectively.

It can also be provided for the first material and/or the second material to be a metal or a metal alloy, preferably platinum or a platinum-based alloy or a platinum-rhodium alloy, particularly preferably a PtRh10 alloy.

A platinum-based alloy is understood to mean an alloy with platinum being the main component. It is preferably understood to mean an alloy with at least 50 atom % platinum.

Metals are easy to process and can be printed. Platinum and platinum-based alloys along with platinum-rhodium alloys are particularly chemically resistant to the glass melt. PtRh10 alloys are particularly preferred due to their higher creep resistance compared to pure platinum.

Furthermore, it can be provided for a step B1) to be performed between step A) and step B):
B1) printing a continuous and/or full-surface coating made of the second material onto the side of the base plate, wherein the at least one tube is printed onto the continuous and/or full-surface coating of the base plate in step B).

As a result, a better connection of the at least one tube to the base plate can be achieved. In addition, a more uniform surface can thus be produced on the side of the base plate, which can then be used for example for a subsequent coating. Particularly preferably, it can be provided for a ceramic coating to be applied to the coating and/or the outside of the at least one tube.

A coating can be effected both by means of powder and with wire. By means of the coating, the base plate can be roughened, wherein the base plate is roughened at least at the locations where powder is to adhere for the at least one tube. Furthermore, the coating can positively influence the distortion of the base plate when the at least one tube is printed on.

It can also be provided for a step D) to be carried out after step B) and after step C):
D) coating the outside of the at least one tube and the side of the base plate on which the at least one tube is printed with a protective layer, in particular with a ceramic protective layer.

As a result, evaporation of the first and second material from the free surfaces during operation of the glass fiber nozzle can be prevented or reduced. This increases the durability of the glass fiber nozzle. At the same time, the rough surface provided by the printing method can be used to produce a stable connection between the coating and the second material.

When producing the protective layer, it is thus particularly preferred if step B1) is carried out before step D), namely printing a continuous or full-surface coating made of the second material onto one side of the base plate, wherein the at least one tube is printed onto the continuous or full-surface coating of the base plate in step B).

Furthermore, it can be provided in methods according to the invention that, in step B), a tube made of the second material is printed onto one side of the base plate, wherein the tube comprises at least one feedthrough, and in step C), before step B) or after step B), a passage is generated in the base plate, wherein the passage through the base plate is connected to at least one of the at least one feedthrough of the tube in such a way that the passage through the base plate forms a common line, which is permeable to the glass melt, with at least one of the at least one feedthrough of the tube, which line leads through the base plate and through the tube.

In this way, a glass fiber nozzle with only one imprint is produced, wherein the tube can have a plurality of feedthroughs and can thus be suitable for the parallel production of a plurality of glass fibers.

In the alternative, it can be provided that, in step B), a plurality of tubes made of the second material are printed onto one side of the base plate, wherein the tubes each comprise at least one feedthrough, and in step C), before step B) or after step B), a plurality of passages are generated in the base plate, wherein the passages through the base plate are in each case connected to at least one of the at least one feedthrough of one of the tubes in each case in such a way that the passages through the base plate form common lines, which are permeable to the glass melt, with at least one of the at least one feedthrough of one tube in each case, which lines lead through the base plate and through the tubes.

In this way, a plurality of glass fibers can be produced in parallel via a plurality of tubes. Each of the tubes can be used individually for the delivery of heat, so that the individual tubes heat up less strongly or quickly. This can improve the durability of the glass fiber nozzle.

Furthermore, it can be provided for the first material to have a higher heat resistance and/or a higher creep resistance than the second material.

As a result, it is achieved that the base plate, which is exposed to the glass melt to a greater extent than the at least one tube, is chemically more stable with respect to the glass melt, but is also more stable against evaporation of components from the first material. As a result, greater durability of the glass fiber nozzle is achieved than in those cases where the base plate would also have a lower heat resistance, wherein at the same time the at least one tube can be printed on the base plate in very variable form with a printing method, even if it has a lower heat resistance due to this. Due to the greater heat resistance and/or creep resistance of the first material, it is possible when using platinum-rhodium alloys for the first material and the second material to use a lower rhodium content for the base plate than for the at least one tube when the base plate has been solidified. As a result, the base plate can be produced from a more cost-effective material with less rhodium than the tubes. Of course, it is also possible for the tubes to have a higher, identical or lower rhodium content than the base plate, so that an optimum can be found always depending on rhodium price, evaporation rate and stability.

When speaking about materials, creeping (also retardation) refers to the time-dependent and temperature-dependent plastic deformation under constant load. A characteristic number for creeping is the creep rate or Norton coefficient. At almost constant temperature, the creep rate follows the Norton creep law. Creep resistance means the maximum tension in order not to exceed a specified creep expansion (within a defined time interval). Similarly, the creep strength can be defined as the maximum tension in order to achieve a specified service life (before a breakage occurs).

Heat resistance is the strength of a material at elevated temperatures. This means that at the temperature of the glass melt, in particular at 1400° C., the strength of the first material is higher than that of the second material. The strength of a material describes its capacity to withstand mechanical stresses before it breaks; it is indicated as mechanical stress (force per cross-sectional area). Failure can be an impermissible deformation, in particular a plastic (permanent) deformation or breakage. Here, strength describes the limit value after which a non-elastic, i.e. irreversible deformation of the material occurs at a defined geometry and load.

The mechanical properties can be determined, for example, using a universal testing machine of the Zwick Roell Z100 type made by Zwick GmbH & Co. KG. The change in length of the samples of the materials can be recorded via a macro fine strain extensometer and the load by means of a 100 kN load cell. For example, the creep limit (yield strength) R_{p0.2}, the tensile strength Rₘ, and the elongation at break &B can be determined at a test speed of 3 mm/min at room temperature and/or 1400° C. The evaluation can be carried out, for example, using the software testXper® made by Zwick GmbH & Co. KG.

The mechanical properties can be determined, for example, using a universal testing machine of the Zwick Roell Z100 type made by Zwick GmbH & Co. KG. The change in length of the samples of the materials can be recorded via a macro fine strain extensometer and the load by means of a 100 kN load cell. For example, the creep limit (yield strength) R_{p0.2}, the tensile strength Rₘ, and the elongation at break &B can be determined at a test speed of 3 mm/min at room temperature and/or 1400° C. The evaluation can be carried out, for example, using the software testXper® made by Zwick GmbH & Co. KG.

Oxide dispersion hardened platinum (Pt DPH) or oxide dispersion hardened platinum-rhodium (PtRh DPH) is preferably used as the first and/or the second material, particularly preferably oxide dispersion hardened platinum-rhodium with 10% by weight Rh and 90% by weight Pt, including production-related impurities (PtRh10 DPH).

The mechanical high-temperature properties of oxide dispersion hardened platinum (Pt DPH), preferably used as the first material, at 1400° C. are: Tensile strength Rₘ 15.6 MPa, yield strength R_{p0.2} 13.6 MPa, elongation at break A 53%, creep strength for 10,000 hours 2.5 MPa and creep resistance at a creep rate of 10⁻⁹ s⁻¹ at 2.4 MPa.

In contrast, PtRh10 components, which were joined by butt welding by means of tungsten inert gas welding (TIG) without the use of additional metal, show significantly lower creep strengths for 100 hours of 6.1 MPa at 1400° C. In comparison, the creep strength of the unwelded PtRh10 DPH for 100 hours is 12 MPa, and for conventional non-oxide dispersion hardened PtRh10 alloy it is 3.8 MPa at 1400° C.

The mechanical high-temperature properties of oxide dispersion hardened platinum (PtRh10 DPH) at 1400° ° C. are characterized by the tensile strength Rₘ 52 MPa, the yield strength R_{p0.2} 40 MPa, the elongation at break A 32%, the creep strength for 10,000 hours 6.8 MPa, and the creep resistance at a creep rate of 10⁻⁹ s⁻¹ at 8.8 MPa.

For the at least one printed tube or for molds, which are produced from powder by means of 3D printing, made from the materials Pt or PtRh10 (both of which are not oxide dispersion hardened), significantly lower mechanical high-temperature properties result at 1400° C., namely a tensile strength Rₘ 8.2 MPa, a yield strength R_{p0.2} 3.9 MPa, an elongation at break A 68% and a creep strength for 10,000 hours 0.6 MPa (for 100 hours 1.4 MPa) for platinum, and a tensile strength Rₘ 35.4 MPa, a yield strength R_{p0.2} 27.8 MPa, an elongation at break A 30% and a creep strength for 10,000 hours 1.3 MPa (for 100 hours 3.8 MPa) for PtRh10. The measured values can be determined using standard methods.

Furthermore, it can be provided that the first material has a different chemical composition than the second material.

In this way, different physical properties between the first material and the second material can be achieved.

Furthermore, it can be provided for the at least one tube to be printed onto the base plate by selective laser melting (SLM), selective laser sintering (SLS), selective electron beam melting (SEBM), laser metal deposition (LMD), 3D direct energy deposition (DED) or selective electron beam sintering (SEBS).

These methods can be used particularly well for the variable and cost-effective production of the at least one tube, in particular using metallic powders. In addition, high-melting noble metals and noble metal alloys, which are preferably used as the second material, can also be printed with these methods.

Furthermore, it can be provided that, during printing of the at least one tube in step B), the following geometric specifications are met: the cross section of the at least one feedthrough is not circular.

Furthermore, it can be provided that, during printing of the at least one tube in step B), the following geometric specifications are met: the at least one tube has a change in the wall thickness in the axial direction.

It can also be provided that, during printing of the at least one tube in step B), the following geometric specifications are met: the wall of the at least one feedthrough has a higher roughness than the surface of the base plate.

Furthermore, it can be provided that, during printing of the at least one tube in step B), the following geometric specifications are met: the at least one tube is double-walled or multi-walled.

Furthermore, it can be provided that, during printing of the at least one tube in step B), the following geometric specifications are met: the at least one feedthrough has a constriction or a widening.

It can also be provided that, during printing of the at least one tube in step B), the following geometric specifications are met: the at least one tube, in addition to the at least one feedthrough, channels for heating or cooling the tube with a heating medium or cooling medium, wherein the heating medium or cooling medium can be liquid or gaseous.

As a result, the strength of printing is used, namely that even complicated geometric shapes can be printed with great variability.

According to a preferred development of the method according to the invention, it can be provided that at least the side of the base plate onto which the at least one tube is printed in step B) is cleaned, rolled, ground, leveled and/or adjusted, in particular finely adjusted and/or finely rolled and cleaned before step B).

This ensures that the at least one tube, in particular all of the plurality of tubes, can subsequently be printed onto the thus treated surface of the base plate by means of a single printing process.

It can also be provided for the base plate to be produced with a planar underside, wherein the at least one tube is printed onto the underside in step B).

It can also be provided that at least three tubes are printed onto the base plate in step B) and that the order of the successively printed tubes is selected during printing in such a way that mechanical distortion of the base plate caused by thermal local stress is kept low during printing, kept low in particular by the fact that no directly adjacent tubes are printed directly one after another.

Alternatively, distortion by an additional coating or an additional material application can be compensated for by applying further tensile/compressive stresses. The resulting distortion is detected optically or capacitively, for example, and an optimal position and quantity (material as well as energy input) for the compensating material application are determined by simulation.

As a result, deformation of the base plate during printing is avoided and the printing process can be completed more quickly. In addition, permanent deformation of the base plate and a weakening of the connection between the base plate and the tubes are avoided.

The building of a plurality of tubes can take place in parallel. Preferably, taking into account the thermally induced distortion, coordination of the exposure sequence and assembly sequence takes place. The building of a tube can be partially carried out in one layer in order to reduce the thermal gradient. With methods such as LMD and DED, tubes can be built in parallel on two sheets mounted opposite each other as base plates, in order to reduce distortion.

Furthermore, it can be provided that in step B), the shape of the at least one feedthrough in the at least one tube is selected to be different from a cylindrical geometry or contains a refraction of an otherwise cylindrical geometry, wherein the shape is preferably selected such that a mixing or swirling of a glass melt flowing through the at least one feedthrough is effected and/or the at least one tube is a plurality of tubes and the feedthroughs of different tubes have different shapes, in particular depending on the position of the tube on the base plate.

As a result, the method can be used to produce certain desired flow properties of the glass melt flowing through. In addition, influences on the position of the tubes, for example with respect to their vicinity to walls of a trough of the glass fiber nozzle, can be compensated for by an individual adaptation of the shape of the feedthroughs in order to produce as uniform glass fibers as possible.

Furthermore, it can be provided that in step B), the at least one tube is printed onto the base plate with a widening as a connection to the base plate, wherein the widening preferably brings about an increase in the connecting surface between the at least one tube and the base plate.

This produces a more stable connection between the at least one tube and the base plate and thus improves the mechanical stability of the glass fiber nozzle.

The objects underlying the present invention are also achieved by a glass fiber nozzle for producing glass fibers from a glass melt, the glass fiber nozzle having a base plate that comprises a first material or consists of the first material, wherein the first material is chemically resistant to a glass melt and dispersion strengthened, at least one tube which is printed from a second material, wherein the at least one tube is printed onto one side of the base plate, wherein the at least one tube in each case comprises at least one feedthrough and wherein the second material is chemically resistant to the glass melt, wherein at least one passage is arranged in the base plate, wherein the at least one passage through the base plate is connected to at least one of the at least one feedthrough of one of the at least one tube in each case in such a way that each of the at least one passage through the base plate forms a common line, which is permeable to the glass melt, with at least one of the at least one feedthrough of an associated tube of the at least one tube, which line leads through the base plate and through the associated tube, wherein the base plate is produced using a method other than the one used for the at least one tube.

In this case, it can be provided for walls of the at least one passage to be delimited by the first material and for walls of the at least one feedthrough to be delimited by the printed second material.

This ensures that the printed second material does not have to be inserted or printed into holes in the base plate. The amount of the printed second material is thus kept low and the durability of the glass fiber nozzle is thereby improved and at the same time the costs for the production thereof are kept low.

Furthermore, it can be provided for the glass fiber nozzle to be produced using a method according to the invention.

As a result, the glass fiber nozzle has the advantages mentioned for the method for the production thereof.

The objects underlying the present invention are further achieved by a method for producing glass fibers from a glass melt with a glass fiber nozzle according to the invention, with which the glass melt flows through the at least one passage in a base plate and through the at least one feedthrough in the at least one tube printed onto the base plate and solidifies after flowing out of the at least one tube to form at least one glass fiber.

It can be provided that a homogenization of the glass melt in the at least one feedthrough is produced during the method, wherein the internal shape of the at least one feedthrough preferably effects the mixing of the glass melt.

The invention is based on the surprising finding that by printing the at least one tube onto the base plate, it is possible to enable a high variability of the tube geometry, wherein the use of a base plate produced by another method makes it possible at the same time to optimize the base plate with respect to other physical parameters, such as, for example, with respect to the chemical durability of the base plate relative to the glass melt or with respect to the high-temperature resistance of the base plate. At the same time, only a small amount of the printing medium has to be consumed compared to when printing the entire continuous line(s) or even the entire base plate together with the at least one tube. Furthermore, welding of the at least one tube to the base plate can be avoided, and weak points of the glass fiber nozzle at the weld seams can thus be avoided. Given the greater roughness of the inner surfaces of the at least one feedthrough of the at least one tube, a better mixing of the glass melt can be achieved during its flow than if the at least one feedthrough had smooth walls.

In comparison to conventional base plates, by directly printing onto a stable, conventionally manufactured base plate, the strength of the base plate can be achieved by a larger load-bearing cross section, by a minimal weld zone that has a reduced strength and by a smaller required pre-drilling diameter in the base plate.

However, advantages are obtained even in comparison to tubes (tips) that are welded in a conventional bushing—even if the tubes were to be produced by 3D printing. This is because printing on a conventional base plate requires significantly less powder or wire or material of the second material than when having to print complete tubes that would have to be welded into the base plate later on. This results in savings of up to 75% of the printing medium or of the powder from which the at least one tube is printed, compared to fully 3D-printed tubes that are welded into the base plate. This results in a significant reduction in the welded or fused material zone, wherein the fused material zone preferably is at least 90% smaller compared to welded tubes. The fused material zone brings about a disadvantageous reduction in strength, which is avoided with the method according to the invention and the device according to the invention.

In addition, the method according to the invention or the glass fiber nozzle according to the invention leads to advantages also in comparison to fully 3D-printed bushing plates including tubes (tips). In the context of the present invention, a method for the production of the base plate other than 3D printing can be used for the tubes and thus a more stable result and/or a more cost-effective production method can be applied. For example, a high-strength oxide dispersion-strengthened platinum or a high-strength oxide dispersion-strengthened platinum-rhodium alloy can be used for the base plate, as a result of which the long-term stability of such a bushing is significantly higher than in the case of fully printed bushing plates. Specifically, these are not printable as oxide dispersion-strengthened platinum variants or platinum-rhodium variants. A shrinking of the base plate can also be avoided if it is cast and/or rolled, for example.

New tube geometries that cannot be produced by conventional methods can be realized. Due to the fact that the at least one tube is 3D-printed and has not been produced by machine subtraction (turned, milled), more complex geometries are possible, which have a positive influence on the glass fiber quality and output and would not be possible with subtractive methods.

The present invention therefore proposes direct 3D printing of the glass fiber tips (the at least one tube) onto a base plate made of a noble metal alloy or of another suitable material combination.

The base plate can already be perforated, or the holes (the at least one passage) can be produced after the tips (of the at least one tube) have been printed on. The shape of the tips can be carried out in a geometry desired by the user. Here, different cross sections, wall thickness profiles, flow-influencing geometries and cross sections, double-walled designs as protective barriers and cooling or heating channels are conceivable.

The tips or tubes can be built on the base plate (for example a sheet) using any 3D printing method.

An allowance may be necessary to allow for reworking measures. For this purpose, the base plate can be cleaned, leveled, polished and/or coated, for example.

A structured 3D-printed surface within or also outside of the at least one tube can be advantageous in order to optimize the component properties in terms of fluid mechanics (inside) or to provide the component with a highly adhesive coating, which reduces or completely prevents evaporation of platinum and/or rhodium.

The glass fibers produced using a method according to the invention are technical glass fibers suitable for applications such as, for example, glass fiber reinforced plastics, the electronics industry (glass fiber reinforced printed circuit boards) and the textile industry (fireproof fabrics).

Further exemplary embodiments of the invention are explained below with reference to eleven figures, but without thereby limiting the invention. In the figures:

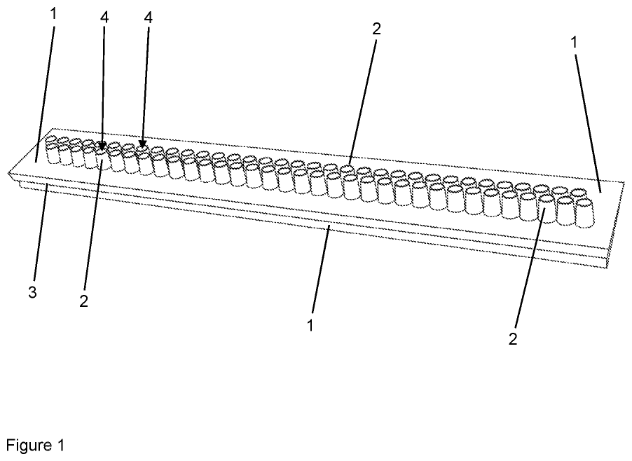

FIG. 1: shows a schematic perspective view of the underside of a base plate of a glass fiber nozzle according to the invention;

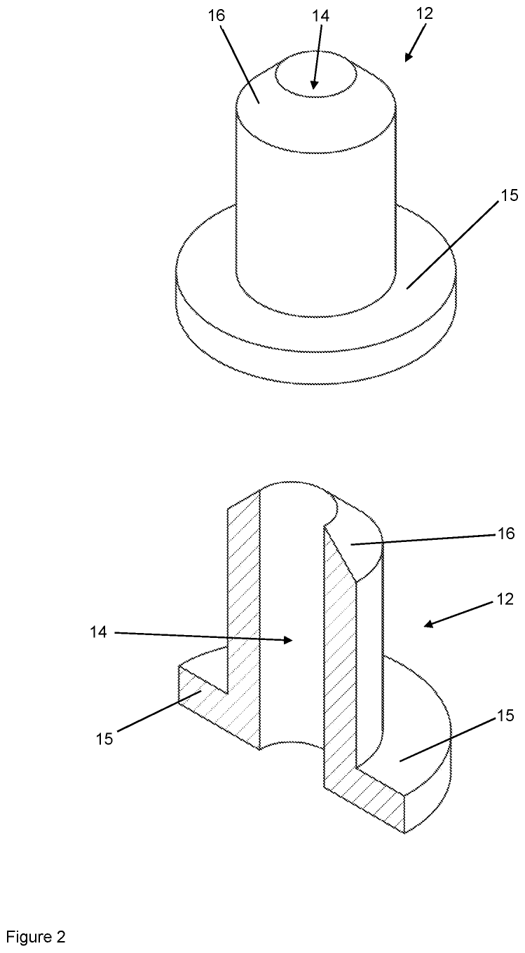

FIG. 2: shows a schematic perspective view (top of FIG. 2) and a schematic perspective cross-sectional view (bottom of FIG. 2) of a printed tube (tip) of a glass fiber nozzle according to the invention;

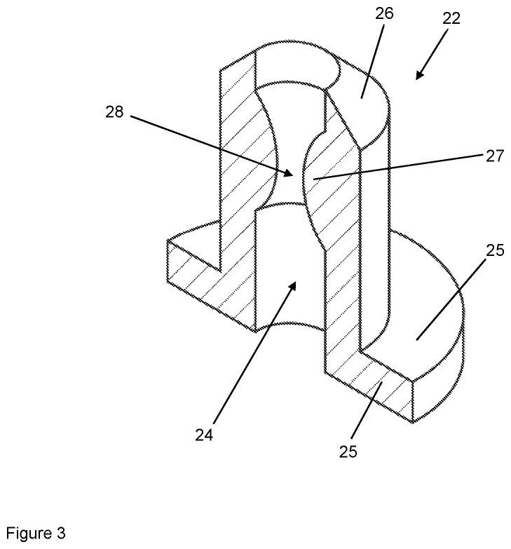

FIG. 3: shows a schematic perspective cross-sectional view of a third exemplary tube (tip) for a glass fiber nozzle according to the invention;

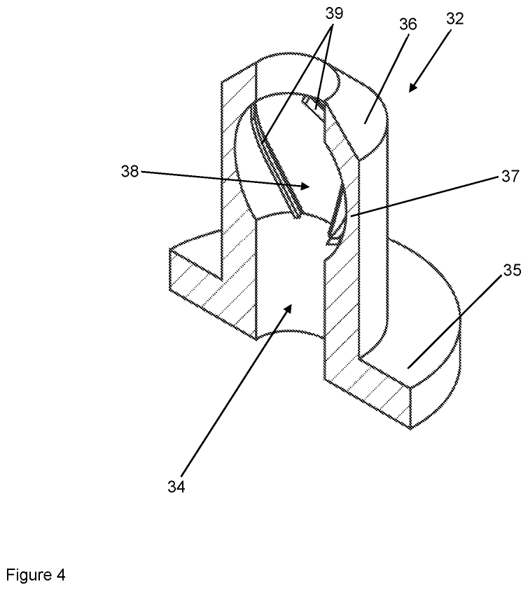

FIG. 4: shows a schematic perspective cross-sectional view of a fourth exemplary tube (tip) for a glass fiber nozzle according to the invention;

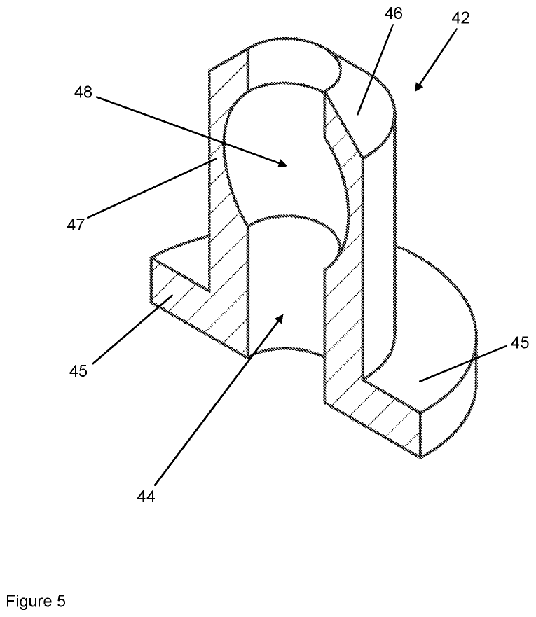

FIG. 5: shows a schematic perspective cross-sectional view of a fifth exemplary tube (tip) for a glass fiber nozzle according to the invention;

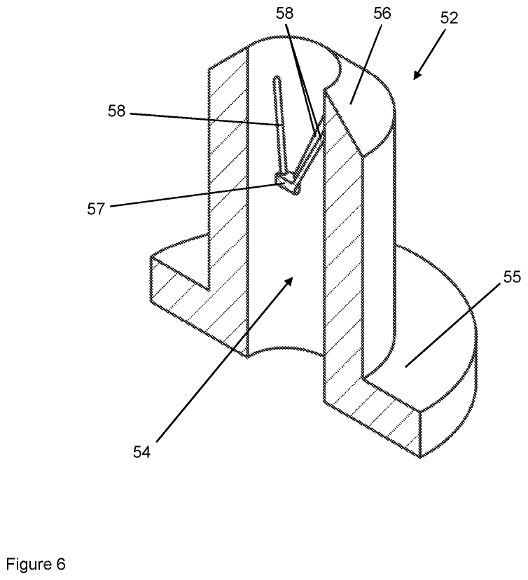

FIG. 6: shows a schematic perspective cross-sectional view of a sixth exemplary tube (tip) for a glass fiber nozzle according to the invention;

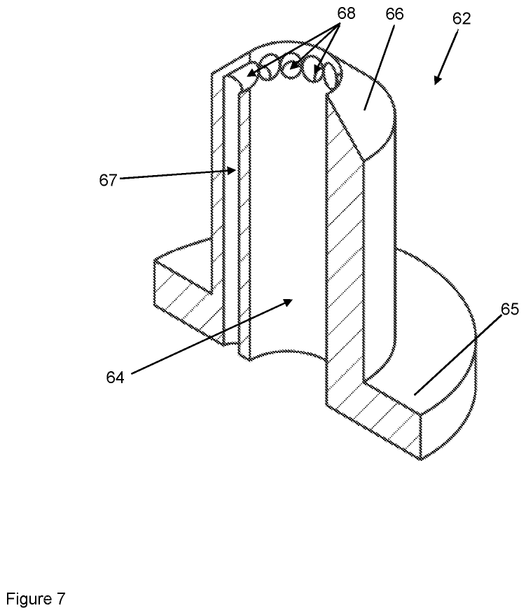

FIG. 7: shows a schematic perspective cross-sectional view of a seventh exemplary tube (tip) for a glass fiber nozzle according to the invention;

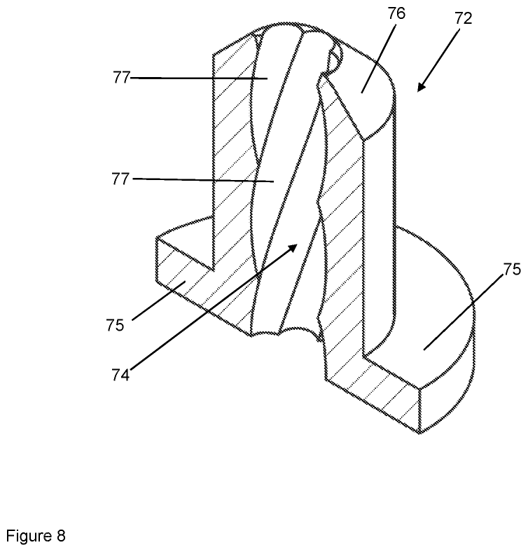

FIG. 8: shows a schematic perspective cross-sectional view of an eighth exemplary tube (tip) for a glass fiber nozzle according to the invention;

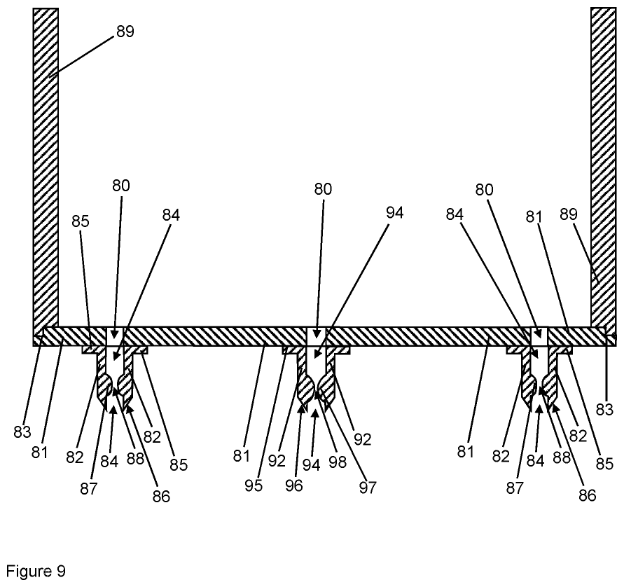

FIG. 9: shows a schematic cross-sectional view of a glass fiber nozzle according to the invention; and

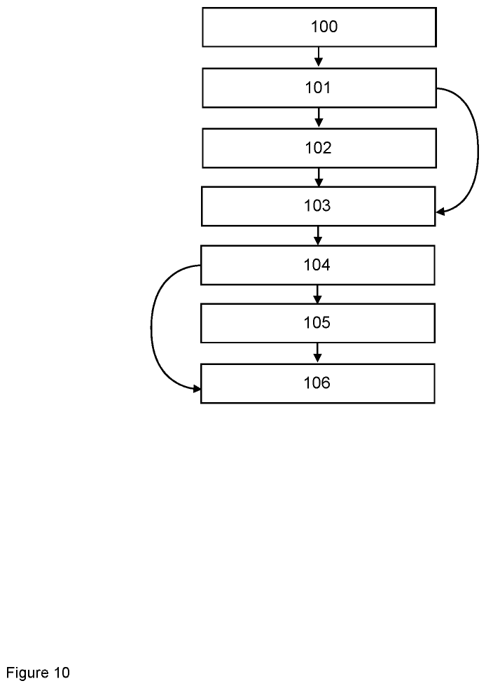

FIG. 10 shows a schematic cross-sectional view of a production of a glass fiber nozzle according to the invention; and

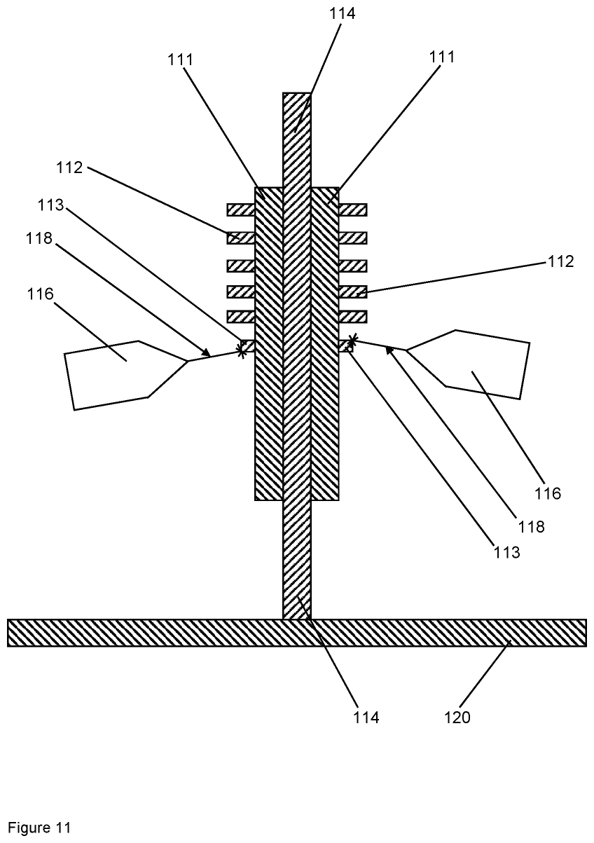

FIG. 11 shows the sequence of a method according to the invention as a flowchart.

FIG. 1 shows a schematic perspective view of the underside of a base plate 1 of a glass fiber nozzle according to the invention. A plurality of tubes 2, also referred to as tips, can be arranged on the underside of the base plate 1 in two rows offset to one another. The tubes 2 can be printed onto the underside of the base plate 1 using a 3D printing method. For this purpose, a metal powder (not shown) can be melted, welded or sintered in layers using a laser in order to build up the tubes 2 in layers on the base plate 1. Alternatively, a metal wire can also be applied together with a laser material deposition (LMD) method. The base plate 1 can have a step 3 via which the base plate 1 can be connected to lateral walls (not shown) (analogous to FIG. 9) in order to form a container for a glass melt (not shown) for a glass fiber nozzle. Each tube 2 can have a continuous feedthrough 4 that extends up to the base plate 1.

Passages are arranged in the base plate 1 (not visible in FIG. 1). The passages can open into the feedthroughs 4 within the tubes 2. The passages can connect the underside of the base plate 1 to the upper side of the base plate 1. The passages can be aligned with the feedthroughs 4 to form a common line that is permeable to a glass melt. The glass melt can then flow out of the feedthroughs 4 through the base plate 1 and through the tubes 2. Glass fibers are formed during the subsequent solidification of the glass melt.

The base plate 1 itself can consist of an oxide dispersion hardened metal or an oxide dispersion hardened metal alloy, in particular of an oxide dispersion hardened platinum or an oxide dispersion hardened platinum-rhodium alloy, particularly preferably of PtRh10 DPH. For hardening, ceramic or other oxidic particles can be distributed in the metal or the metal alloy.

FIG. 2 shows a second exemplary embodiment of a tube 12 that can be printed onto a base plate (not shown in FIG. 2) in order to realize a glass fiber nozzle according to the invention. For this purpose, the tube 12 in FIG. 2 at the top is shown completely in a schematic perspective view and in FIG. 2 at the bottom in a schematic perspective cross-sectional view. As can be clearly seen in the cross-sectional view, a continuous cylindrical feedthrough 14 can be arranged in the tube 12. The side of the tube 12 fastened to the base plate (not shown) can have a widening 15 in the form of a foot. The widening 15 increases the connecting surface to the base plate and can thus bring about a more stable connection between the base plate and the tube 12.

The tube 12 can have a conical tip 16 on its side opposite the widening 15. The conical tip 16 causes the glass melt to flow out of the feedthrough 14 more uniformly. Starting with the widening 15 on a base plate (not shown), the tube 12 can be printed in layers from a metal powder. Alternatively, a metal wire can also be applied together with a laser material deposition (LMD) method. Preferably, a plurality of these tubes 12 are printed on the base plate. A passage can be provided for each tube 12 in the base plate (see FIG. 9). The tube 12 can be positioned or printed on the base plate in such a way that the passage is aligned with the feedthrough 14 so that the passage and feedthrough form a common line for the glass melt.

Due to the use of a 3D printing method, a large number of different shapes and geometries can be used for the production of tubes. FIGS. 3 to 8 show six further exemplary embodiments for tubes 22, 32, 42, 52, 62, 72 for this purpose, which are suitable for implementing a glass fiber nozzle according to the invention individually, in a plurality or also mixed with one another.

FIG. 3 shows a third exemplary embodiment of a tube 22 that can be printed onto a base plate (not shown in FIG. 3) in order to realize a glass fiber nozzle according to the invention. For this purpose, the tube 22 in FIG. 3 is shown in a schematic perspective cross-sectional view. As can be clearly seen in the cross-sectional view, a continuous feedthrough 24 can be arranged in the tube 22. The side of the tube 22 fastened to the base plate (not shown) can have a widening 25 in the form of a foot. The widening 25 increases the connecting surface to the base plate and can thus bring about a more stable connection between the base plate and the tube 22.

The tube 22 can have a conical tip 26 on its side opposite the widening 25. The conical tip 26 causes the glass melt to flow out of the feedthrough 24 more uniformly. The feedthrough 24 can be formed to be rotationally symmetric and can be formed to be cylindrical in the region of the widening 25 and of the conical tip 26. A circumferential bead-shaped thickening 27 of the wall of the feedthrough 24 can be arranged in the feedthrough 24. The thickening 27 of the wall leads to a constriction 28 of the feedthrough 24 in the region of the thickening 27. The constriction 28 causes a change in the flow of a glass melt that flows through the feedthrough 24. The constriction 28 can, for example, change the flow rate as a function of the radius perpendicular to the flow in the glass melt. In particular, a mixing of the glass melt can be effected directly before it flows out of the conical tip 26 of the tube 22.

Starting with the widening 25 on a base plate (not shown), the tube 22 can be printed in layers from a metal powder, in particular from a platinum powder or a platinum-rhodium powder, particularly preferably from a powder made of PtRh10 DPH. Alternatively, a metal wire can also be applied together with a laser material deposition (LMD) method. Preferably, a plurality of these tubes 22 are printed on the base plate. A passage can be arranged for each tube 22 in the base plate (see FIG. 9). The tube 22 can be positioned or printed on the base plate in such a way that the passage is aligned with the feedthrough 24 so that the passage and feedthrough form a common line for the glass melt.

FIG. 4 shows a fourth exemplary embodiment of a tube 32 that can be printed onto a base plate (not shown in FIG. 4) in order to realize a glass fiber nozzle according to the invention. For this purpose, the tube 32 in FIG. 4 is shown in a schematic perspective cross-sectional view. As can be clearly seen in the cross-sectional view, a continuous feedthrough 34 can be arranged in the tube 32. The side of the tube 32 fastened to the base plate (not shown) can have a widening 35 in the form of a foot. The widening 35 increases the connecting surface to the base plate and can thus bring about a more stable connection between the base plate and the tube 32.

The tube 32 can have a conical tip 36 on its side opposite the widening 35. The conical tip 36 causes the glass melt to flow out of the feedthrough 34 more uniformly. The feedthrough 34 can be formed to be substantially rotationally symmetric and can be formed to be cylindrical in the region of the widening 35 and of the conical tip 36. A circumferential spherical segment-shaped thinning 37 of the wall of the feedthrough 34 can be arranged in the feedthrough 34. The thinning 37 of the wall leads to a widening 38 of the feedthrough 34 in the region of the thinning 37. Projecting strips 39 wound on the inner side of the wall can be arranged within the widening 38, which in the manner of a thread cause a torque on a glass melt flowing through the feedthrough 34. The widening 38 and the strips 39 cause a change in the flow of a glass melt that flows through the feedthrough 34. The widening 38 can, for example, change the flow rate as a function of the radius perpendicular to the flow in the glass melt. In particular, a mixing of the glass melt can be effected directly before it flows out of the conical tip 36 of the tube 32.

Starting with the widening 35 on a base plate (not shown), the tube 32 can be printed in layers from a metal powder, in particular from a platinum powder or a platinum-rhodium powder, particularly preferably from a powder made of PtRh10 DPH. Alternatively, a metal wire can also be applied together with a laser material deposition (LMD) method. Preferably, a plurality of these tubes 32 are printed on the base plate. A passage can be arranged for each tube 32 in the base plate (see FIG. 9). The tube 32 can be positioned or printed on the base plate in such a way that the passage is aligned with the feedthrough 34 so that the passage and feedthrough form a common line for the glass melt.

FIG. 5 shows a fifth exemplary embodiment of a tube 42 that can be printed onto a base plate (not shown in FIG. 5) in order to realize a glass fiber nozzle according to the invention. For this purpose, the tube 42 in FIG. 5 is shown in a schematic perspective cross-sectional view. As can be clearly seen in the cross-sectional view, a continuous feedthrough 44 can be arranged in the tube 42. The side of the tube 42 fastened to the base plate (not shown) can have a widening 45 in the form of a foot. The widening 45 increases the connecting surface to the base plate and can thus bring about a more stable connection between the base plate and the tube 42.

The tube 42 can have a conical tip 46 on its side opposite the widening 45. The conical tip 46 causes the glass melt to flow out of the feedthrough 44 more uniformly. The feedthrough 44 can be formed to be rotationally symmetric and can be formed to be cylindrical in the region of the widening 45 and of the conical tip 46. A circumferential spherical segment-shaped thinning 47 of the wall of the feedthrough 44 can be arranged in the feedthrough 44. The thinning 47 of the wall leads to a widening 48 of the feedthrough 44 in the region of the thinning 37. The widening 48 causes a change in the flow of a glass melt that flows through the feedthrough 44. The widening 48 can, for example, change the flow rate as a function of the radius perpendicular to the flow in the glass melt. In particular, a mixing of the glass melt can be effected directly before it flows out of the conical tip 46 of the tube 42.

Starting with the widening 45 on a base plate (not shown), the tube 42 can be printed in layers from a metal powder, in particular from a platinum powder or a platinum-rhodium powder, particularly preferably from a powder made of PtRh10 DPH. Alternatively, a metal wire can also be applied together with a laser material deposition (LMD) method. Preferably, a plurality of these tubes 42 are printed on the base plate. A passage can be arranged for each tube 42 in the base plate (see FIG. 9). The tube 42 can be positioned or printed on the base plate in such a way that the passage is aligned with the feedthrough 44 so that the passage and feedthrough form a common line for the glass melt.

FIG. 6 shows a sixth exemplary embodiment of a tube 52 that can be printed onto a base plate (not shown in FIG. 6) in order to realize a glass fiber nozzle according to the invention. For this purpose, the tube 52 in FIG. 6 is shown in a schematic perspective cross-sectional view. As can be clearly seen in the cross-sectional view, a continuous feedthrough 54 can be arranged in the tube 52. The side of the tube 52 fastened to the base plate (not shown) can have a widening 55 in the form of a foot. The widening 55 increases the connecting surface to the base plate and can thus bring about a more stable connection between the base plate and the tube 52.

The tube 52 can have a conical tip 56 on its side opposite the widening 55. The conical tip 56 causes the glass melt to flow out of the feedthrough 54 more uniformly. The feedthrough 54 can be formed to be largely cylindrical and can be formed to be completely cylindrical in the region of the widening 55 and of the conical tip 56. In the feedthrough 54, a core 57 can be arranged in the center, i.e. on the cylinder axis of the cylindrical feedthrough 54. The core 57 can be held with five webs 58, wherein the webs 58 connect the core 57 to the inner wall of the feedthrough 54. For this purpose, the webs 58 can protrude obliquely from the inner wall of the feedthrough 54 against the intended flow direction of the glass melt. The core 57 and to a certain extent also the webs 58 cause a change in the flow of a glass melt that flows through the feedthrough 54. The core 57 can, for example, slow down the flow rate of the flow in the glass melt in the middle of the feedthrough 54. In particular, a mixing of the glass melt can be effected directly before it flows out of the conical tip 56 of the tube 52.

Starting with the widening 55 on a base plate (not shown), the tube 52 can be printed in layers from a metal powder, in particular from a platinum powder or a platinum-rhodium powder, particularly preferably from a powder made of PtRh10 DPH. Alternatively, a metal wire can also be applied together with a laser material deposition (LMD) method. Preferably, a plurality of these tubes 52 are printed on the base plate. A passage can be arranged for each tube 52 in the base plate (see FIG. 9). The tube 52 can be positioned or printed on the base plate in such a way that the passage is aligned with the feedthrough 54 so that the passage and feedthrough form a common line for the glass melt.

FIG. 7 shows a seventh exemplary embodiment of a tube 62 that can be printed onto a base plate (not shown in FIG. 7) in order to realize a glass fiber nozzle according to the invention. For this purpose, the tube 62 in FIG. 7 is shown in a schematic perspective cross-sectional view. As can be clearly seen in the cross-sectional view, a continuous central feedthrough 64 can be arranged in the tube 62. The side of the tube 62 fastened to the base plate (not shown) can have a widening 65 in the form of a foot. The widening 65 increases the connecting surface to the base plate and can thus bring about a more stable connection between the base plate and the tube 62.

The tube 62 can have a conical tip 66 on its side opposite the widening 65. The conical tip 66 causes the glass melt to flow out of the central feedthrough 64 more uniformly. The central feedthrough 64 can be formed to be cylindrical. A plurality of outer continuous feedthroughs 67 can be arranged in the wall of the central feedthrough 64, which open into the central feedthrough 64 via openings 68 in the region of the conical tip 66. The outer feedthroughs 67 can be tubular and can preferably be cylindrical in regions. The central feedthrough 64 can have a larger diameter than the outer feedthroughs 67. During operation of the glass fiber nozzle, the glass melt can flow through the central feedthrough 64 and through the outer feedthroughs 67. Alternatively, it is also possible to allow air or another gas to flow through the outer feedthroughs 67 in order to cool the tube 62 and/or to change the glass melt or to change the flow of the glass melt. In particular, a mixing of the glass melt can be effected directly before it flows out of the conical tip 66 of the tube 62.

Starting with the widening 65 on a base plate (not shown), the tube 62 can be printed in layers from a metal powder, in particular from a platinum powder or a platinum-rhodium powder, particularly preferably from a powder made of PtRh10 DPH. Alternatively, a metal wire can also be applied together with a laser material deposition (LMD) method. Preferably, a plurality of these tubes 62 are printed on the base plate. A passage can be arranged for each tube 62 in the base plate (see FIG. 9). The tube 62 can be positioned or printed on the base plate in such a way that the passage is aligned with the central feedthrough 64 so that the passage and feedthrough form a common line for the glass melt or that the passage is aligned with the central feedthrough 64 and the outer feedthroughs 67 so that they form a common line for the glass melt.

FIG. 8 shows an eighth exemplary embodiment of a tube 72, which can be printed onto a base plate (not shown in FIG. 8) in order to realize a glass fiber nozzle according to the invention. For this purpose, the tube 72 in FIG. 8 is shown in a schematic perspective cross-sectional view. As can be clearly seen in the cross-sectional view, a continuous feedthrough 74 can be arranged in the tube 72. The side of the tube 72 fastened to the base plate (not shown) can have a widening 75 in the form of a foot. The widening 75 increases the connecting surface to the base plate and can thus bring about a more stable connection between the base plate and the tube 72.

The tube 72 can have a conical tip 76 on its side opposite the widening 75. The conical tip 76 causes the glass melt to flow out of the feedthrough 74 more uniformly. The feedthrough 74 can be shaped in the manner of a thread with a very steep pitch and can otherwise be cylindrical. For this purpose, a plurality of circumferential threaded grooves 77 of the wall of the feedthrough 74 can be arranged in the feedthrough 74. The threaded grooves 77 can transfer a torque to a glass melt flowing through the feedthrough 74 and thus effect a change in the flow of a glass melt flowing through the feedthrough 74. In particular, a mixing of the glass melt can be effected directly before it flows out of the conical tip 76 of the tube 72.

Starting with the widening 75 on a base plate (not shown), the tube 72 can be printed in layers from a metal powder, in particular from a platinum powder or a platinum-rhodium powder, particularly preferably from a powder made of PtRh10 DPH. Alternatively, a metal wire can also be applied together with a laser material deposition (LMD) method. Preferably, a plurality of these tubes 72 are printed on the base plate. A passage can be arranged for each tube 72 in the base plate (see FIG. 9). The tube 72 can be positioned or printed on the base plate in such a way that the passage is aligned with the feedthrough 74 so that the passage and feedthrough form a common line for the glass melt.

FIG. 9 shows a schematic cross-sectional view of a glass fiber nozzle according to the invention. The glass fiber nozzle can have a base plate 81 having a plurality of passages 80. A plurality of tubes 82, 92, also referred to as tips, can be arranged on the underside of the base plate 81. The tubes 82, 92 can be printed onto the underside of the base plate 81 using a 3D printing method. For this purpose, a metal powder (not shown) can be melted, welded or sintered in layers using a laser in order to build up the tubes 82, 92 in layers on the base plate 81. The tubes 82, 92 can be printed around the passages 80, or the passages 80 can be drilled into the base plate 81 or otherwise generated in the base plate 81 after printing the tubes 82, 92 on. The base plate 81 can have a step 83 via which the base plate 81 can be connected to circumferential side walls 89 to form a container for a glass melt (not shown) for the glass fiber nozzle. Each tube 82, 92 can have a continuous feedthrough 84, 94, which extends up to the base plate 81. The passages 80 can open into the feedthroughs 84, 94 within the tubes 82, 92. The passages 80 can connect the underside of the base plate 81 to the upper side of the base plate 81. The feedthroughs 84, 94 can be aligned with the passages 80, so that the feedthroughs 84, 94 together with the passages 80 form a common line for the glass melt. The glass melt can then flow out of the feedthroughs 84, 94 through the base plate 81 and through the tubes 82, 92. Glass fibers are formed during the subsequent solidification of the glass melt.

The base plate 81 itself can consist of an oxide dispersion hardened metal or an oxide dispersion hardened metal alloy, in particular of an oxide dispersion hardened platinum or an oxide dispersion hardened platinum-rhodium alloy, particularly preferably of PtRh10 DPH. For hardening, ceramic or other oxidic particles can be distributed in the metal or the metal alloy.

The tubes 82, 92 according to FIG. 8 represent ninth and tenth exemplary embodiments printed on the base plate 81. The sides of the tubes 82, 92 fastened to the base plate 81 can have widenings 85, 95 in the form of feet. The widenings 85, 95 increase the connecting surface to the base plate 81 and can thus bring about a more stable connection between the base plate 81 and the tubes 82, 92. It can also be provided that the entire side of the base plate 81 onto which the tubes 82, 92 are printed (bottom of FIG. 8) is printed with a thin layer (not visible in FIG. 8) that consists of the same material as the tubes 82, 92.

The tubes 82, 92 can have conical tips 86, 96 on their sides opposite the widening 85, 95. The conical tips 86, 96 cause the glass melt to flow out of the feedthroughs 84, 94 more uniformly. The feedthroughs 84, 94 can be formed to be rotationally symmetric and can be formed to be cylindrical in the region of the widenings 85, 95 and of the conical tips 86, 96. Circumferential bead-shaped thickenings 87, 97 of the walls of the feedthroughs 84, 94 can be arranged in the feedthroughs 84, 94. The thickenings 87, 97 of the wall lead to the formation of constrictions 88, 98 in the feedthroughs 84, 94 in the region of the thickenings 87, 97. The constrictions 88, 98 cause a change in the flow of a glass melt that flows through the feedthroughs 84, 94. The constrictions 88, 98 can, for example, change the flow rate as a function of the radius perpendicular to the flow in the glass melt. In particular, a mixing of the glass melt can be effected directly before it flows out of the conical tips 86, 96 of the tube 82, 92. The middle tube 92 has a narrower constriction 98 of the feedthrough 94 than the constrictions 88 of the feedthroughs 84 of the two outer tubes 82. As a result, allowance can be made for a different flow of the glass melt through the feedthroughs 84, 94 as a function of the distance between the tubes 82, 92 and the side walls 89 in order to achieve a uniform flow of the glass melt and thus of the produced glass fibers.

Starting with the widening 85, 95, the tubes 82, 92 can be printed onto the base plate 81 in layers from a metal powder, in particular from a platinum powder or a platinum-rhodium powder, particularly preferably from a powder made of PtRh10 DPH. Alternatively, a metal wire can also be applied together with a laser material deposition (LMD) method. Preferably, the layers for building these tubes 82, 92 are printed onto the base plate 81 in such a way that two adjacent tubes 82, 92 are not printed directly one after another onto the base plate 81. As a result, the heat produced during the printing process can dissipate better and there is less chance of local overheating of the base plate 81. An undesired deformation of the base plate 81 can thereby be avoided. A passage 80 can be provided for each tube 82, 92 in the base plate 81. The tubes 82, 92 can be positioned or printed on the base plate 81 in such a way that each of the passages 80 is aligned with exactly one of the feedthroughs 84, 94 so that both together form a common line for the glass melt.

The sequence of a method according to the invention is described below with reference to FIG. 10 and FIG. 9.

In a first working step 100, the base plate 81 can be produced by casting from the melt. In this case, oxidic particles can be distributed or generated in the melt. After solidification of the melt, the base plate 81 can be formed in a second working step 101 by rolling and/or by a further temperature treatment and further hardened. At this point, the step 83 can also be introduced into the base plate 81.

In an optional third working step 102, the underside of the base plate 81 can be leveled and/or pretreated and cleaned in order to subsequently be able to print on it.

In a fourth working step 103, the base plate 81 can be provided for printing. For this purpose, the base plate 81 can be fastened in a 3D printer. It is also possible to provide a base plate 81 produced with a method other than the one specified in the following fifth working step 104. The method according to the invention can thus start with the fourth working step 103.

In the fifth working step 104, the tubes 82, 92 can be printed in layers onto the base plate 81. For this purpose, a powder (not shown) can be melted, sintered or welded in layers with a laser onto the base plate 81 or onto previous layers.

In an optional sixth working step 105, the surface of the base plate 81 with the tubes 82, 92 can be cleaned, recompressed, polished or coated. In particular, a ceramic coating can be applied to the surface of the underside of the base plate that is rough due to 3D printing (if printed) and to the outside of the tubes 82, 92.

In an optional seventh step 106, the base plate 81 can be welded or otherwise connected to circumferential side walls 89. Before that, the side walls 89 can be produced using the same method as for the base plate 81.

As a result, a glass fiber nozzle according to the invention is obtained. The side walls 89 and the base plate 81 can form a container for a glass melt. The glass melt can flow out of this container and through the passages 80 and the feedthroughs 84, 94 and thus form the glass fibers. The same method can also be used to produce glass fiber nozzles with tubes having other geometries, for example the geometries shown in FIGS. 2 to 7. In addition, the geometries can also be mixed easily as desired.

FIG. 11 shows a schematic cross-sectional view of a production of a glass fiber nozzle according to the invention. Here, a plurality of tubes 112 can be built up on two base plates 111 using a laser method. The base plates 111 can be sheets of dispersion hardened platinum or dispersion hardened PtRh10 alloy. Semi-finished tubes 113 under construction that are located on the base plates 111 are also shown in FIG. 11. The base plates 111 can be fastened on both sides on a carrier 114 and two lasers 116 can be used for the parallel construction on both sides. The laser beams 118 can impinge the semi-finished tubes 113 for additive manufacturing, as shown in FIG. 11. The carrier 114 can be mounted on a stand 120.

Laser metal deposition (LMD) or 3D direct energy deposition (DED) can be applied to implement the method. With methods such as LMD and DED, tubes 112 can be built in parallel on two base plates 111 mounted opposite each other, in order to reduce distortion.

The features of the invention disclosed in the above description and in the claims, figures and exemplary embodiments, both individually and in any desired combination, can be essential for implementing the invention in its various embodiments.

### LIST OF REFERENCE SIGNS

1, 81, 111 Base plate
2, 12, 22, 32, 42, 52, 62, 72, 82, 92, 112 Tube (tip)
3, 83 Step
4, 14, 24, 34, 44, 54, 64, 74, 84, 94 Feedthrough
15, 25, 35, 45, 55, 65, 75, 85, 95 Widening
16, 26, 36, 46, 56, 66, 76, 86, 96 Conical tip
27, 87, 97 Thickening of the wall
28, 88, 98 Constriction of the feedthrough
37, 47 Thinning of the wall
38, 48 Widening of the feedthrough
39 Strips
57 Core
58 Web
67 Feedthrough
68 Opening
77 Threaded groove
80 Passage
89 Side wall
100, 101, 102, 103 Working step
104, 105, 106 Working step
113 Semi-finished tube
114 Carrier
116 Laser
118 Laser beam
120 Stand

1. A method for producing glass fiber nozzles, which are provided for producing glass fibers from a glass melt, the method comprising the steps of:
A) providing or producing a base plate comprising a first material, wherein the first material is chemically resistant to the glass melt, and dispersion strengthened,
B) printing at least one tube made of a second material onto one side of the base plate, wherein the at least one tube in each case comprises at least one feedthrough and wherein the second material is chemically resistant to the glass melt,
C) generating at least one passage in the base plate, wherein the at least one passage through the base plate is connected to at least one of the at least one feedthrough in each case of one of the at least one tube in such a way that each of the at least one passage through the base plate forms a common line, which is permeable to the glass melt, with at least one of the at least one feedthrough of an associated tube of the at least one tube, which line leads through the base plate and through the associated tube, and wherein
the base plate is produced using a method other than the one used for the at least one tube.

2. The method according to claim 1, wherein
the base plate is not produced using a laser melting method, a laser sintering method, an electron beam melting method or an electron beam sintering method.

3. The method according to claim 1, wherein
the base plate is not produced using a layered 3D printing method.

4. The method according to claim 1, wherein
a step A1) takes place before step A)
A1) producing the base plate using a method comprising melt casting and/or rolling or comprising melt casting and subsequent rolling.

5. The method according to claim 1, wherein
a metal material, in particular an oxide dispersion-strengthened metal material, is used as the first material, wherein the first material delimits all surfaces coming into contact with the glass melt.

6. The method according to claim 1, wherein
a dispersion-strengthened noble metal or a dispersion-strengthened noble metal alloy which is dispersion-strengthened with ceramic particles or with ceramic ZrO₂ particles is used as the first material.

7. The method according to claim 1, wherein
a platinum or platinum-rhodium alloy, each of which is oxide dispersion hardened with ceramic particles, with oxidic ceramic particles or with ceramic ZrO₂ particles, is used as the first material.

8. The method according to claim 1, wherein
a PtRh10 alloy which is oxide dispersion hardened with ceramic particles, with ceramic particles, with oxidic ceramic particles or with ceramic ZrO₂ particles is used as the first material.

9. The method according to claim 1, wherein
the first material and/or the second material is a metal or a metal alloy.

10. The method according to claim 1, wherein
the first material and/or the second material is platinum or a platinum-based alloy or a platinum-rhodium alloy or a PtRh10 alloy.

11. The method according to claim 1, wherein
a step B1) takes place between step A) and step B):
B1) printing a continuous and/or full-surface coating made of the second material onto the side of the base plate, wherein the at least one tube is printed onto the continuous and/or full-surface coating of the base plate in step B).

12. The method according to claim 1, wherein
a step D) takes place after step B) and after step C):
D) coating the outside of the at least one tube and the side of the base plate on which the at least one tube is printed with a protective layer, in particular with a ceramic protective layer.

13. The method according to claim 1, wherein
B) printing a tube made of the second material onto one side of the base plate, wherein the tube comprises at least one feedthrough, and
C) generating, before step B) or after step B), a passage in the base plate, wherein the passage through the base plate is connected to at least one of the at least one feedthrough of the tube in such a way that the passage through the base plate forms a common line, which is permeable to the glass melt, with at least one of the at least one feedthrough of the tube, which line leads through the base plate and through the tube.

14. The method according to claim 1, wherein
B) printing a plurality of tubes made of the second material onto one side of the base plate, wherein the tubes in each case have at least one feedthrough, and
C) generating, before step B) or after step B), a plurality of passages in the base plate, wherein the passages through the base plate are in each case connected to at least one of the at least one feedthrough in each case of one of the tubes in such a way that the passages through the base plate form common lines, which are permeable to the glass melt, with at least one of the at least one feedthrough of one tube in each case, which lines lead through the base plate and through the tubes.

15. The method according to claim 1, wherein
the first material has a higher heat resistance and/or a higher creep resistance than the second material.

16. The method according to claim 1, wherein
the first material has a different chemical composition than the second material.

17. The method according to claim 1, wherein
the at least one tube is printed onto the base plate by selective laser melting, selective laser sintering, selective electron beam melting laser metal deposition, 3D direct energy deposition or selective electron beam sintering.

18. The method according to claim 1, wherein
when printing the at least one tube in step B), at least one of the following geometric specifications is met:
1. the cross section of the at least one feedthrough is not circular;
2. the at least one tube has a change in the wall thickness in the axial direction;
3. the wall of the at least one feedthrough has a higher roughness than the surface of the base plate;
4. the at least one tube is double-walled or multi-walled;
5. the at least one feedthrough has a constriction or a widening; and
6. the at least one tube in addition to the at least one feedthrough channels for heating or cooling the tube with a heating medium or cooling medium, wherein the heating medium or cooling medium is liquid or gaseous.

19. The method according to claim 1, wherein
at least the side of the base plate onto which the at least one tube, is printed in step B) is cleaned, rolled, ground, leveled and/or adjusted, in particular finely adjusted and/or finely rolled and cleaned before step B).

20. The method according to claim 1, wherein
at least three tubes are printed onto the base plate in step B) and the order of the successively printed tubes is selected during printing in such a way that mechanical distortion of the base plate caused by thermal local stress is kept low during printing.

21. The method according to claim 19, wherein
the thermal local stress during printing is kept low due to the fact that no directly adjacent tubes are printed directly one after the other.

22. The method according to claim 1, wherein
in step B), the shape of the at least one feedthrough in the at least one tube is selected to be different from a cylindrical geometry or contains a refraction of an otherwise cylindrical geometry.

23. The method according to claim 21, wherein
the shape of the at least one feedthrough in the at least one tube is selected such that a mixing or swirling of a glass melt flowing through the at least one feedthrough is effected.

24. The method according to claim 21, wherein
the at least one tube is a plurality of tubes, and the feedthroughs of different tubes have different shapes, in particular depending on the position of the tube on the base plate.

25. The method according to claim 1, wherein
in step B), the at least one tube is printed onto the base plate with a widening as a connection to the base plate.

26. The method according to claim 24, wherein
the widening brings about an increase in the connecting surface between the at least one tube and the base plate.

27. The method according to claim 1, wherein
in step B), a powdery second material or a wire-shaped second material is used.

28. A glass fiber nozzle for producing glass fibers from a glass melt, the glass fiber nozzle comprising
a base plate comprising a first material or consisting of the first material, wherein the first material is chemically resistant to a glass melt and dispersion strengthened,
at least one tube printed from a second material, wherein the at least one tube is printed on one side of the base plate, wherein the at least one tube in each case comprises at least one feedthrough and wherein the second material is chemically resistant to the glass melt, wherein
at least one passage is arranged in the base plate, wherein the at least one passage through the base plate is connected to at least one of the at least one feedthrough in each case of one of the at least one tube in such a way that each of the at least one passage through the base plate forms a common line, which is permeable to the glass melt, with at least one of the at least one feedthrough of an associated tube of the at least one tube, which line leads through the base plate and through the associated tube, wherein
the base plate is produced using a method other than the one used for the at least one tube.

29. The glass fiber nozzle according to claim 27, wherein
walls of the at least one passage are delimited by the first material and walls of the at least one feedthrough are delimited by the printed second material.

30. The glass fiber nozzle according to claim 27, wherein
the glass fiber nozzle is produced using a method comprising the steps of:
A) providing or producing a base plate comprising a first material, wherein the first material is chemically resistant to the glass melt, and dispersion strengthened,
B) printing at least one tube made of a second material onto one side of the base plate, wherein the at least one tube in each case comprises at least one feedthrough and wherein the second material is chemically resistant to the glass melt,
C) generating at least one passage in the base plate, wherein the at least one passage through the base plate is connected to at least one of the at least one feedthrough in each case of one of the at least one tube in such a way that each of the at least one passage through the base plat forms a common line, which is permeable to the glass melt, with at least one of the at least one feedthrough of an associated tube of the at least one tube, which line leads through the base plate and through the associated tube, and wherein
the base plate is produced using a method other than the one used for the at least one tube.

31. A method for producing glass fibers from a glass melt with a glass fiber nozzle according to claim 27, wherein
the glass melt flows through the at least one passage in a base plate and through the at least one feedthrough in the at least one tube printed onto the base plate and solidifies to form at least one glass fiber after flowing out of the at least one tube.
